(19) United States
(12) Patent Application Publication
(10) Pub. No.: US 2011/0141013 A1
(43) Pub. Date: Jun. 16, 2011

(54) USER-INTERFACE APPARATUS AND METHOD FOR USER CONTROL

(75) Inventor: Kim N. Matthews, Watchung, NJ (US)

(73) Assignee: Alcatel-Lucent USA, Incorporated, Murray Hill, NJ (US)

(21) Appl. No.: 12/636,967

(22) Filed: Dec. 14, 2009

(51) Int. Cl. G06F 3/033

(52) U.S. Cl. 345/158

(57) ABSTRACT

An apparatus comprising at least two sensors, a pointing device and an object-recognition unit. The sensors are at different locations and are capable of detecting a signal from at least a portion of a user. The pointing device is configured to direct a user-controllable signal that is detectable by the sensors. The object-recognition unit is configured to receive output from the sensors, and, to determine locations of the portion of the user and of the pointing device based on the output. The object-recognition unit is also configured to calculate a target location pointed to by the user with the pointing device, based upon the determined locations of the portion of the user and of the pointing device.

### TECHNICAL FIELD

The present disclosure is directed, in general, to user interfaces, more specifically apparatuses and methods having a pointer-based user interfaces and a medium for performing such methods.

### BACKGROUND

This section introduces aspects that may be helpful to facilitating a better understanding of the inventions. Accordingly, the statements of this section are to be read in this light. The statements of this section are not to be understood as admissions about what is in the prior art or what is not in the prior art.

There is great interest in improving user interfaces with various apparatuses such as such as televisions, computers or other appliances. Handheld remote control units become inadequate or cumbersome for complex signaling tasks. Mouse and keyboard interfaces may be inadequate or inappropriate for certain environments. The recognition of hand gestures to interact with graphical user interfaces (GUIs) can be computationally expensive, difficult to use, and can suffer from being limited to single-user interfaces.

### SUMMARY

One embodiment is an apparatus comprising at least two sensors, a pointing device and an object-recognition unit. The sensors are at different locations and are capable of detecting a signal from at least a portion of a user. The pointing device is configured to direct a user-controllable signal that is detectable by the sensors. The object-recognition unit is configured to receive output from the sensors, and, to determine locations of the portion of the user and of the pointing device based on the output. The object-recognition unit is also configured to calculate a target location pointed to by the user with the pointing device, based upon the determined locations of the portion of the user and of the pointing device.

Another embodiment is a method. The method comprises determining a location of a user using output from at least two sensors positioned at different locations. The output includes information from signals from at least a portion of the user and received by the sensors. The method also comprises determining a location of a pointing device using the output from the sensors, the output including information from user-controllable signals from the pointing device and received by the sensors. The method also comprises calculating a target location that the user pointed to with the pointing device, based upon the determined locations of the portion of the user and of the pointing device.

Another embodiment is a computer-readable medium, comprising, computer-executable instructions that, when executed by a computer, perform the above-described method.

### BRIEF DESCRIPTION OF THE DRAWINGS

The embodiments of the disclosure are best understood from the following detailed description, when read with the accompanying FIGUREs. Corresponding or like numbers or characters indicate corresponding or like structures. Various features may not be drawn to scale and may be arbitrarily increased or reduced in size for clarity of discussion. Reference is now made to the following descriptions taken in conjunction with the accompanying drawings, in which:

FIG. 1 presents a block diagram of an example single-user apparatus of the disclosure;

FIG. 2 presents a block diagram of an example multi-user apparatus of the disclosure; and

FIG. 3 presents a flow diagram of an example method of the disclosure, such as methods of using any embodiments of the apparatus discussed in the context of FIGS. 1-2.

### DETAILED DESCRIPTION

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof. Additionally, the term, “or,” as used herein, refers to an non-exclusive or, unless otherwise indicated. Also, the various embodiments described herein are not necessarily mutually exclusive, as some embodiments can be combined with one or more other embodiments to form new embodiments.

Embodiments of the disclosure improve the user interface experience by providing an interface that can facilitate, include or be: (a) intuitive and self-configuring, e.g., by allowing the user to simply point at a location which in turn can result in a predefined action to be performed; (b) rapid and accurate responsiveness to user commands; (c) low-cost implementation; (d) adaptable to multiuser configurations; and (e) adaptability to fit within the typical user environments in commercial or residential settings.

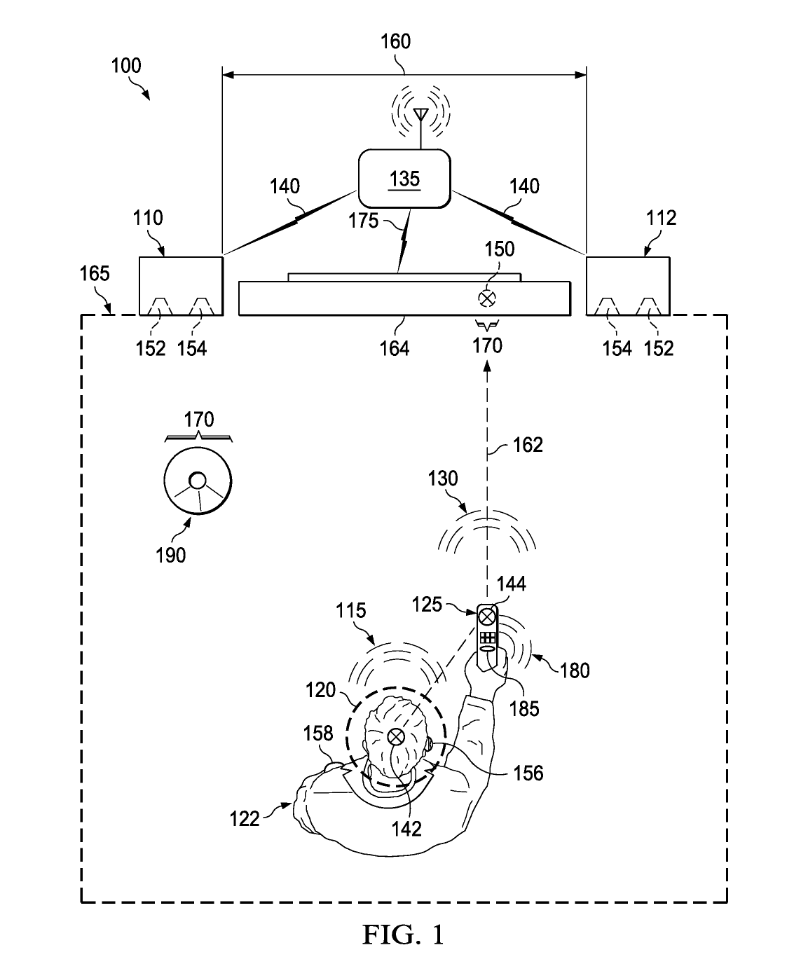

FIG. 1 presents a block diagram of an example apparatus 100 of the disclosure. In some embodiments, the apparatus 100 can include a user or portion thereof (e.g., a robotic or non-robotic user). In some embodiments the apparatus 100 can be or include a media device such as a television, computer, radio, or, a structure such as a lamp, oven or other appliances.

The apparatus 100 shown in FIG. 1 comprises at least two sensors 110, 112 at different locations. The sensors 110, 112 are capable of detecting a signal 115 from at least a portion 120 of a user 122. The apparatus 100 also comprises a pointing device 125 that is configured to direct a user-controllable signal 130 that is also detectable by the at least two sensors 110, 112. The apparatus 100 further comprises an object-recognition unit 135. The object-recognition unit 135 is configured to receive output 140 from the sensors 110, 112 and to determine a location 142 of the portion 120 of the user 122 and a location 144 of the pointing device 125 based on the output 140. The object-recognition unit 135 is also configured to calculate a target location 150 pointed to by the user 122 with the pointing device 125, based upon the determined locations 142, 144 of the portion 120 of the user 122 and of the pointing device 125.

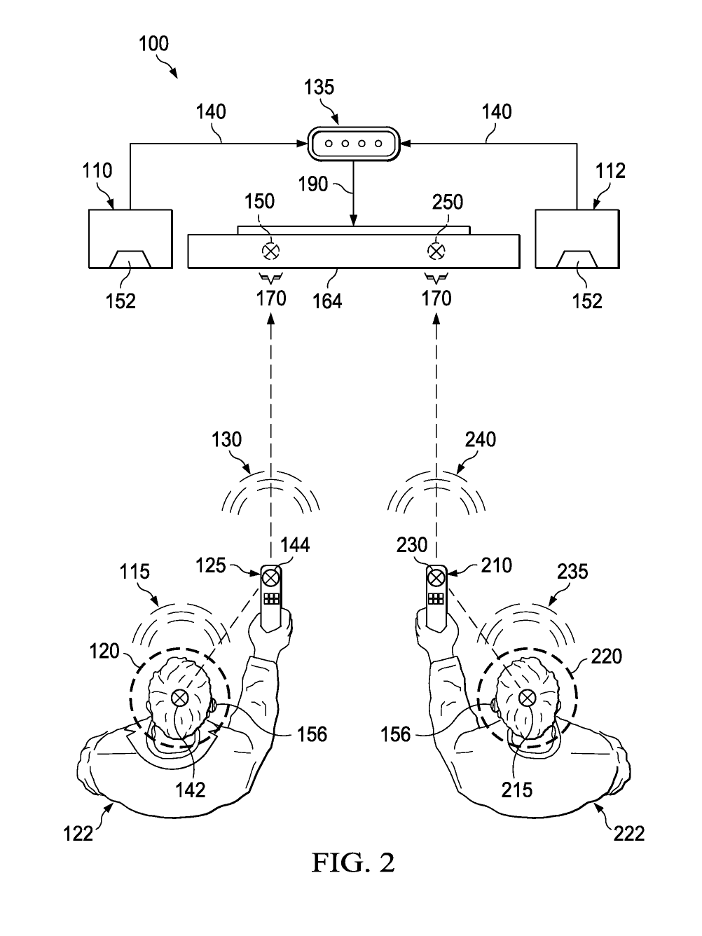

Based upon the disclosure herein one skilled in the art would understand how to configure the apparatus to serve as an interface for multiple users. For instance, as shown for the example apparatus 200 in FIG. 2, in addition to the above-described components, the apparatus 200 can further include a second pointing device 210. The object-recognition unit 135 can be further configured to determine a second location 215 of at least a portion 220 of a second user 222, and, a second location 230 of the second pointing device 210, based on the output 140 received from the sensors 110, 112. The output 140 includes information about a signal 235 from the portion 220 of the second user 222 and a second user-controllable signal 240 from the second pointing device 210. The object-recognition unit 135 is also configured to calculate a target location 250 pointed to by the second user 222 with the second pointing device 210, based upon the determined second locations 215, 230 of the portion 220 of said second user 222 and the second pointing device 210.

The signal from the user (or users) and the pointing device (or devices) can have or include a variety of forms of energy. In some cases, for example, at least one of the signals 115, 130 from the pointing device 125, or, the user 122 (or signals 235, 240 from other multiple users 222 and devices 210) includes ultrasonic wavelengths of energy. In some cases, for example, the signal 130 from the pointing device 125, and, the signal 115 from the user 122 both include electromagnetic radiation (e.g., one or more of radio, microwave, terahertz, infrared, visible, ultraviolet frequencies). In some cases, to facilitate uniquely identifying each of the signals 115, 130 from the user 122 and pointing-device 125 (or signals 235, 240 from other multiple users 222 and devices 210) the signals 115, 130 can have different frequencies of electromagnetic radiation. As an example, the pointing device 125 can emit or reflect a signal 130 that includes an infrared frequency, while the user 122 (or portion 120 thereof, such as the user's head) emits or reflects a signal 115 at a visible frequency. In other cases however, the signal 115, 130 can have electromagnetic radiation, or ultrasound radiation, of the same frequency. As an example, the pointing device can emit or reflects a signal 130 that includes an infrared frequency, while a portion 120 (e.g., the eyes) of the user 122 reflects an infrared signal 115 substantially the same frequency (e.g., a less than an about 1 percent difference between frequencies of the signals 115, 130). One skilled in the art would be familiar with various code division multiple access techniques that could be used to differentiate the signals 115, 130, or, additional signals from other users and pointing devices. As another example, the signal 130 from the pointing device 125 and the signal 115 from the user 122 can include different channel codes, such as time or frequency duplexed codes.

Based upon the present disclosure one skilled in the art would understand how to configure or provide sensors 110, 112 that can detect the signals 115, 130. For instance, when the pointing device 125 emits a signal 130 that includes pulses of ultrasound, or the signal 115 from the user includes pulses of ultrasound reflected off of the user 122, then the sensors 110, 112 include ultrasound detectors 152. For instance, when the pointing device 125 includes an infrared light emitting diode (LED) or laser, then the sensors 110, 112 can include infrared or other electromagnetic radiation detectors 154.

In some cases, the sensors can include detectors that can sense a broad range of frequencies of electromagnetic radiation. For instance, in some embodiments the sensors 110, 112 can each include a detector 154 that is sensitive to both visible and infrared frequencies. Consider the case, for example, where the signal 115 from user 122 includes visible light reflected off of the head 120 of the user 122, and, the pointing device 125 includes an LED that emits infrared light. In such cases, it can be advantageous for the sensors 110, 112 to be video cameras that are sensitive to visible and infrared light. Or, in other cases, for example, the signal 115 from the user 122 includes signals reflected off of the user 122 and the signal 130 from the pointing device 125 includes signals reflected off of the pointing device 125 (e.g., both the reflected signals 115, 130 can include visible or infrared light) and the sensors 110, 112 include a detector 154 (e.g., visible or infrared light detector) that can detect the reflected signals 115, 130. Positioning the sensors 110, 112 at different locations is important to determining the position of the locations 142, 144 by procedures such as triangulation. The output 140 from the sensors 110, 112 can be transmitted to the object-recognition unit 135 by wireless (e.g., FIG. 1) or wired (e.g., FIG. 2) communication means.

In some embodiments, it can be desirable to attach a signal emitter 156 to the user 122. In such cases, the signal 115 from the user 122 can be or include the signal from the emitter 156. Using such an emitter 156 can facilitate a more accurate determination of the location 142 of the user 122 or portion 120 thereof. A more accurate determination of the location 142, in turn, can facilitate more accurate calculation of the target location 150 being pointed to. For instance, in some cases, the apparatus 100 includes an infrared LED emitter 156 attached to the head portion 120 of the user 122 and the sensors 110, 112 are configured to detect signals from the emitter 156.

In some embodiments, one or both of the signals 115, 130 from the user 122 or the pointing device 125 can be passive signals which are reflected off of the user 122 or the pointing device 125. For instance ambient light reflecting off of the portion 120 of the user 122 can be the signal 115. Or, the signal 115 from the user 122 can be a signal reflected from an energy-reflecting device 158 (e.g., a mirror) that the user 122 is wearing. Similarly, the signal 130 from the pointing device 125 can include light reflected off of the pointing device 125. The sensors 110, 112 can be configured to detect the signal 115 from the reflecting device 158 or the signal 130 reflected from the pointing device 125.

The object-recognition unit 135 can include or be a computer, circuit board or integrated circuit that is programmed with instructions to determine the locations 142, 144 of the user 122, or portion 120 thereof and the pointing device 125. One skilled in the art would be familiar with object-recognition processes, and how to adapt such processes to prepare instructions to determine the locations 142, 144 from which the signals 115, 130 emanate from, and that are within a sensing range of the sensors 110, 112. One skilled in the art would be familiar with signal filtering and averaging processes into computer-readable instructions, and how to adapt such processes to prepare instructions to distinguish the signals 115, 130 from background noise in the vicinity of, or reflecting off of, the user 122 or point device 125. Provided that a distance 164 separating the sensors 110, 112 (e.g., in a range of about 0.5 to meters in some embodiments) is known, then the object-recognition unit 135 can be programmed to determine the locations 142, 144 (e.g., by triangulation). From the determined locations 142, 144, the target location 150 can be calculated, e.g., by determining a vector 162 from the user location 142 to the pointing device location 144 and extrapolating the vector 162.

As further illustrated in FIG. 1, in some cases the object-recognition unit 135 can be located near the sensors 110, 112, pointing device 125, and user 122. In other cases, the object-recognition unit 135 can be remotely located, but still be in communication with one or more other components of the apparatus 100 (e.g., the sensors 110, 112 or optional display unit 164).

In some cases, the apparatus 100 can further including a display unit 164. In other cases the display unit 164 is not part of the apparatus 100. As shown in FIG. 1, in some cases, the sensors 110, 112 can be at different locations (e.g., separate locations) in a performance area 165 that are near (e.g., in the same room) the display unit 164.

The display unit 164 can be or include any mechanism that presents information that a user 122 can sense. E.g., the display unit 164 can be or include a video display mechanism such as a video screen, or other display (e.g., LED display) of an appliance (e.g., oven, or air conditioner control panel), or actual status of an appliance (e.g., the on-off state of a light source such as a lamp). The display unit 164 can be or include an audio display unit like a radio or compact-disk player, or other appliance having an audio status indicator (e.g., a tone, musical note, or voice). The display unit 164 can be or include both a video and audio display, such as a television, a game console, a computer system or other multi-media device.

The performance area 165 can be any space within which the display unit 164 can be located. For instance, the performance area 165 can be a viewing area in front of a display unit 164 configured as a visual display unit. For instance, the performance area 165 can be a listening area in the vicinity (e.g., hearing distance) of a display unit 164 configured as an audio display unit. The performance area 165 can be or include the space in room or other indoor space, but in other cases, can be or include an outdoor space, e.g., within hearing or viewing distance of the display unit 164.

In some embodiments of the apparatus the object-recognition unit 135 can be coupled to the display unit 164, e.g., by wired electrical (e.g., FIG. 2) or wireless (e.g., FIG. 1) communication means (e.g., optical, radiofrequency, or microwave communication systems) that are well-know to those skilled in the art. In some cases, the object-recognition unit 135 can be configured to alter the display unit 164, based upon the target location 150. For instance, the display unit 164 can be altered when the target location 150 is at or within some defined location 170 in the performance area 165. As illustrated, the defined location 170 can correspond to a portion of the display unit 164 itself, while in other cases, the defined location 170 could correspond to a structure (e.g., a light source or a light switch) in the performance area 165. The location 170 could be defined by a user 122 or defined as some default location by the manufacturer or provider of the apparatus 100.

In some embodiments, the object-recognition unit 135 can be configured to alter a visual display unit 164 so as to represent the target location 150, e.g., as a visual feature on the display unit 164. As an example, upon calculating that the target location 150 corresponds to (e.g., is at, or within), a defined location 170, the object-recognition unit 135 can send a control signal 175 (e.g., via wired or wireless communication means) to cause at least a portion of the display unit 164 to display a point of light, an icon, or other visual representation of the target location 150. Additionally, or alternatively, the object-recognition unit 135 can be configured to alter the display unit 164, that includes an audio display, to represent the target location 150, e.g., as an audio representation of the display unit 164.

For instance, based upon the target location 150 being at the defined location 170 in the performance area 165, the object-recognition unit 135 can be configured to alter information presented by the display unit 164. As an example, when the target location 150 is at a defined location 170 on the screen of a visual display unit 164, or, is positioned over a control portion of the visual display unit 164 (e.g., a volume or channel selection control button of a television display unit 164) then the object-recognition unit 135 can cause the display unit 164 to present different information (e.g., change the volume or channel).

Embodiments of the object-recognition unit 135 and the pointing device 125 can be configured to work in cooperation to alter the information presented by the display unit 164 by other mechanisms. For instance, in some cases, when the target location 150 is at a defined location 170 in the performance area 165, the object-recognition unit 135 is configured to alter information presented by the display unit 164 when a second signal 180 is emitted from the pointing device 125. For example, the pointing device 125 can further include a second emitter 185 (e.g., ultrasound, radiofrequency or other signal-emitter), that is activatable by the user 122 when the target location 150 coincides with a defined location 170 on the display unit 164 or other location in the defined location 170. As an example, in some cases, only when the user 122 points at the defined location 170 with the pointing device 125, can a push-button on the pointing device 125 be activated to cause a change in information presented by the display unit 164 (e.g., present a channel selection menu, volume control menu, or other menus familiar to those skilled in the art).

In some embodiments, the object-recognition unit 135 can be configured to alter the state of a structure 190. For instance, upon the target location 150 being at a defined location 170, the object-recognition unit 135 can be configured to alter the on/off state of a structure 190 such as a light source structure 190. In some cases the structure 190 may be a component of the apparatus 100 while in other cases the structure 190 is not part of the apparatus 100. In some cases, such as illustrated in FIG. 1, the structure 190 can be near the apparatus 100, e.g., in a performance area 165 of a display unit 164. In other cases, the structure 190 can be remotely located away from the apparatus 100. For instance, the object-recognition unit 135 could be connected to a communication system (e.g., the internet or phone line) and configured to send a control signal 175 that causes a change in the state of a remotely-located structure (not shown).

Another embodiment of the disclosure is a method of using an apparatus. For instance, the method can be or include a method of using a user-interface, e.g., embodied as, or included as part, of the apparatus. For instance, the method can be or include a method of controlling a component of the apparatus (e.g., a display unit) or controlling an appliance that is not part of the apparatus (e.g., a display unit or other appliance).

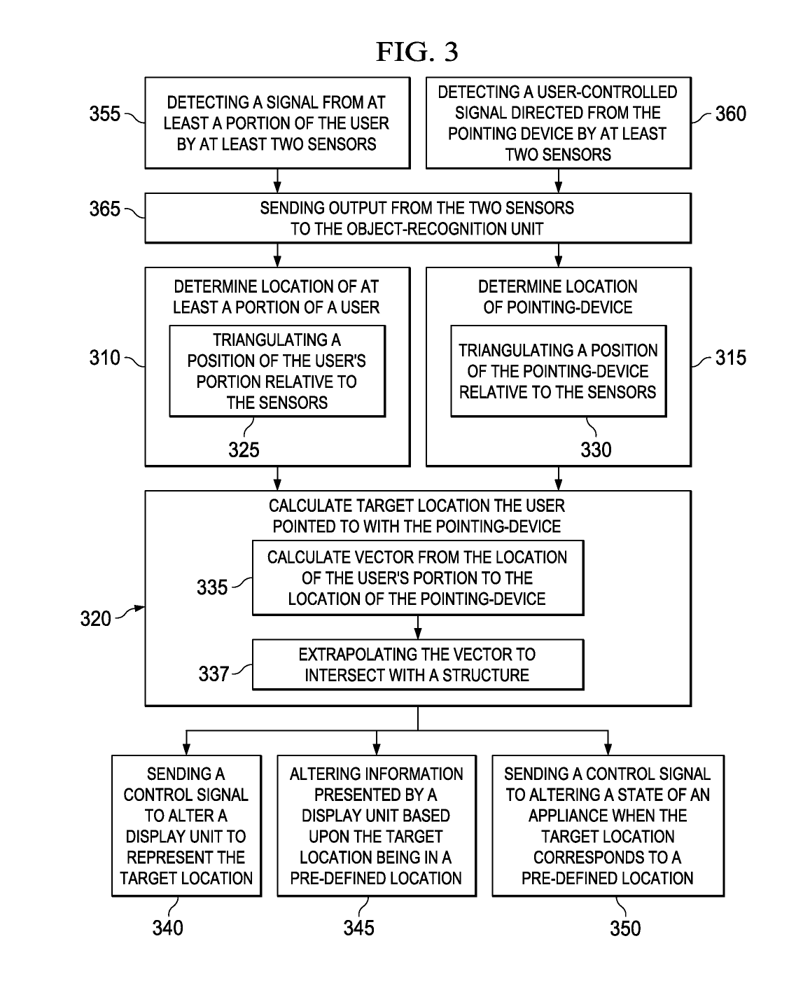

FIG. 3 presents a flow diagram of an example method of using an apparatus such as any of the example apparatuses 100, 200 discussed in the context of FIGS. 1-2.

With continuing reference to FIGS. 1 and 2, the example method depicted in FIG. 3 comprises a step 310 of determining a location 142 of a user 122 using output 140 received from at least two sensors 110, 112 positioned at different locations. The output 140 includes information from signals 115 received by the sensors 110, 112, from at least a portion 120 of the user 122. The method depicted in FIG. 3 also comprises a step 315 of determining a location 144 of a pointing device 125 using the output 140 from the sensors 110, 112, the output 140 including information from user-controllable signals 130, received by the sensors 110, 112, from the pointing device. The method depicted in FIG. 3 further comprises calculating a target location 150 that the user 122 pointed to with the pointing device 125, based upon the determined locations 142, 144 of the portion 120 of the user 122 and of the pointing device 125.

In some embodiments of the method, one or more of the steps 310, 315, 320 can be performed by the object recognition unit 135. In other embodiments, one or more of these steps 310, 315, 320 can be performed by another device, such as a computer in communication with the object recognition unit 135 via, e.g., the internet or phone line.

Determining the locations 142, 144 in steps 310, 315 can include object-recognition, signal filtering and averaging, and triangulation procedures familiar to those skilled in the art. For instance, as further illustrated in FIG. 3, in some embodiments of the method, determining the location 142 of the portion 120 of the user 122 (step 310) includes a step 325 of triangulating a position of the portion 120 relative to the sensors 110, 112. Similarly, in some embodiments, determining the location 144 of the pointing device 125 (step 315) includes a step 330 of triangulating a position of the pointing device 125 relative to the sensors 110, 112. One skilled in the art would be familiar with procedures to implement trigonometric principles of triangulation in a set of instructions based on the output 140 from the sensors 110, 112 in order to determine the positions of locations 142, 144 relative to the sensors 110, 112. For example, a computer could be programmed to read and perform such a set of instructions to determine the locations 142, 144.

Calculating the target location 150 that the user points to in step 320 can also include the implementation of trigonometric principles familiar to those skilled in the art. For instance, calculating the target location 150 (step 320) can include a step 335 of calculating a vector 155 from the location 142 of the portion 120 of the user 122 to the location 144 of the pointing device 125, and, a step 337 of extrapolating the vector 162 to intersect with a structure. The structure being pointed to by the user 122 can include a component part of the apparatus 100 (e.g., the sensors 110, 112, or the object-recognition unit 135), other than the pointing device 125 itself, or, a display unit 164 or a structure 190 (e.g., an appliance, wall, floor, window, item of furniture) in the vicinity of the apparatus 100.

As also illustrated in FIG. 3, the some embodiments of method can include steps to control various structures based upon the target location 150 corresponding to a defined location 170. In some embodiments, the method further includes a step 340 of sending a control signal 175 to alter a display unit 164 to represent the target location 150. For example, the object-recognition unit 135 (or a separate control unit) could send a control signal 175 to alter the display unit 164 to represent the target location 150. Some embodiments of the method further include a step 345 of altering information presented by a display unit 164 based upon the target location 150 being in a defined location 170. Some embodiments of the method further include a step 350 of sending a control signal 175 to alter the state of a structure 190 when the target location 150 corresponds to a defined location 170.

As further illustrated in FIG. 3, some embodiments of the method can also include detecting and sending signals from the user and pointing device to the object-recognition unit. For instance, the method can include a step 355 of detecting a signal 115 from at least a portion 120 of the user 122 by the at least two sensors 110, 112. The some embodiments of the method can include a step 360 of detecting a user-controllable signal 130 directed from the pointing device 125 by the at least two sensors 110, 112. The some embodiments of the method can include a step 365 of sending output 140 from the two sensors 110, 112 to an object-recognition unit 135, the output 140 including information corresponding to signals 115, 130 from the portion 120 of the user 122 and from the pointing device 125.

A person of ordinary skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods

It should also be appreciated by those skilled in the art that any block diagrams, such as shown in FIGS. 1-2, herein can represent conceptual views of illustrative circuitry embodying the principles of the disclosure. Similarly, it will be appreciated that the flow diagram depicted in FIG. 3 represent various processes which may be substantially represented in computer-readable medium and so executed by a computer or processor.

For instance, another embodiment of the disclosure is a computer-readable medium. The computer readable media can be embodied as any of the above described computer storage tools. The computer-readable medium comprises computer-executable instructions that, when executed by a computer, perform at least method steps 310, 315 and 320 as discussed above in the context of FIGS. 1-3. In some cases, the computer-readable medium comprises computer-executable instructions that also include 325-345. In some cases the computer-readable medium is a component of a user interface apparatus, such as embodiments of the apparatuses 100, 200 depicted in FIGS. 1-2. In some cases, for instance, the computer-readable medium can be memory or firmware in an object-recognition unit 135 of the apparatus 100. In other cases, the computer-readable medium be a hard disks, CDs, floppy disks in a computer that is remotely located from the object-recognition unit 135 but sends the computer-executable instructions to the object-recognition unit 135.

Although the embodiments have been described in detail, those of ordinary skill in the art should understand that they could make various changes, substitutions and alterations herein without departing from the scope of the disclosure.

What is claimed is:

1. An apparatus, comprising:
at least two sensors at different locations, wherein said sensors are capable of detecting a signal from at least a portion of a user;
a pointing device configured to direct a user-controllable signal that is detectable by said sensors; and
an object-recognition unit configured to:
receive output from said sensors,
determine locations of said portion of said user and of said pointing device based on said output, and
calculate a target location pointed to by said user with said pointing device, based upon said determined locations of said portion of said user and of said pointing device.

2. The apparatus of claim 1, further including a second pointing device, and wherein said object-recognition unit is further configured to:
determine second locations of at least a portion of a second user, and, of said second pointing device based on said output, and
calculate a target location pointed to by said second user with said second pointing device, based upon said determined second locations of said portion of said second user and of said second pointing device.

3. The apparatus of claim 1, wherein said signal from said pointing device, and, said signal from said user both include electromagnetic radiation.

4. The apparatus of claim 1, wherein at least one of said signal from said pointing device, or, said signal from said user includes ultrasonic wavelengths of energy.

5. The apparatus of claim 1, wherein said signal from said user includes signals reflected off of said user, or, said user-controllable signal from said pointing device includes signals reflected off of said pointing device.

6. The apparatus of claim 1, wherein said signal from said user includes infrared wavelengths of light generated from an emitter attached to said portion of said user, and, said sensors include a detector that can detect infrared wavelengths of light.

7. The apparatus of claim 1, wherein said signal from said user is reflected from a reflecting surface that said user is wearing, and, said sensors are configured to detect said signal from said reflecting surface.

8. The apparatus of claim 1, further including a display unit, wherein upon said target location being at a defined location in a performance area, said object-recognition unit is configured to alter said display unit so as to represent said target location.

9. The apparatus of claim 1, further including a display unit, wherein, upon said target location being at a defined location in a performance area, said object-recognition unit is configured to alter information presented by said display unit.

10. The apparatus of claim 1, further including a display unit, wherein, upon said target location being at a defined location in a performance area, said object-recognition unit is configured to alter information presented by said display unit when a second signal is emitted from said pointing device.

11. The apparatus of claim 1, wherein, upon said target location being at a defined location, said object-recognition unit is configured to alter a state of an appliance.

12. A method, comprising:
determining a location of a user using output received from at least two sensors positioned at different locations, said output including information from signals from at least a portion of said user and received by said sensors;
determining a location of a pointing device using said output from said sensors, said output including information from user-controllable signals from said pointing device and received by said sensors; and
calculating a target location that said user pointed to with said pointing device, based upon said determined locations of said portion of said user and of said pointing device.

13. The method of claim 12, wherein determining said location of said portion of said user includes triangulating a position of said portion relative to said sensors.

14. The method of claim 12, wherein determining said location of said pointing device includes triangulating a position of said pointing device relative to said sensors.

15. The method of claim 12, wherein calculating said target location further includes calculating a vector from said location of said portion to said location of said pointing device, and extrapolating said vector to intersect with a structure.

16. The method of claim 15, further including altering information presented by an information display unit based upon said target location.

17. The method of claim 16, further including sending a control signal to alter a state of an appliance when said target location corresponds to a defined location.

18. The method of claim 15, further including sending a control signal to alter a display unit to represent said target location.

19. A computer-readable medium, comprising:
computer-executable instructions that, when executed by a computer, perform the method steps of claim 12.

20. The computer-readable medium of claim 19, wherein said computer-readable medium is a component of a user interface apparatus.
